(19) United States
(12) Patent Application Publication
(10) Pub. No.: US 2021/0198946 A1
(43) Pub. Date: Jul. 1, 2021

(54) LEVELING AND STABILIZING ACCESSORY FOR LADDERS

(71) Applicant: LaVerne E. Nitz, Clearwater, FL (US)

(72) Inventor: LaVerne E. Nitz, Clearwater, FL (US)

(21) Appl. No.: 17/094,812

(22) Filed: Nov. 11, 2020

Related U.S. Application Data
(60) Provisional application No. 62/933,697, filed on Nov. 11, 2019.

(51) Int. Cl. E06C 7/42; E06C 7/44; E06C 7/46

(52) U.S. Cl. CPC E06C 7/423; E06C 7/46; E06C 7/44

(57) ABSTRACT

Described herein is an improved ladder leg extender and leveler assembly including an elongate frame member or structure which can be fixed in a flush relation to a ladder leg side rail and secured to at least two ladder rungs. Each elongate frame member includes a slidably engage elongate leg extension which engages a height adjustment member or actuator that is located on a surface of the elongate frame member. The height adjustment member operates via a spring actuated pin or rod which engages a series of pre-set slots on the elongate leg extension to adjust the height of the ladder on either side. Also, a pivoting ladder stabilizing element which is extendable. This greatly provided additional stability and security.

### CLAIM OF PRIORITY

This application claims priority to and the benefit of US Provisional application with the same title and having Ser. No. 62/933,697 and filing date of Nov. 11, 2019, which is hereby incorporated by reference in its entirety.

### FIELD AND BACKGROUND OF THE INVENTION

The invention relates generally to devices and accessories for leveling ladders Although it is desirable when erecting a ladder to rest the bottom of the side rails on a substantially flat horizontal surface, it is not uncommon for ladders to be used at locations that do not provide a level surface. The use of a straight or A-frame ladder at such a location can be quite hazardous to the user. Various expedients have been used such as placing blocks or shims under the feet of the side rail to level the ladder, but such temporary devices are quite unsafe.

Ladder levelers attachable to the side rails of ladders have been proposed in the prior art but are complicated and time consuming to attach and secure properly. Other levelers attach directly to the rung or rungs on the inside portion of the ladder creating issues for the users as they climb up and down the ladder.

Therefore, there exists a need for a ladder leveler that can be mounted easily, quickly and securely to most ladders which is also lightweight.

### SUMMARY OF THE INVENTION

The present invention recognizing the problems of past ladder attachments for extending and leveling ladders provides a novel and unique ladder leg extender and leveler accessory which is straightforward and economical in manufacture and assembly, which assures ready mounting to ladder legs with minimal bending stresses during ladder usage and which minimizes the risks of inadvertent lock release or detachment and that is lightweight. The invention advantageously addresses the aforementioned deficiencies by providing a quick mounting ladder leveler device that is also lightweight in a mechanical version and secure. A simple and inexpensive attachment for existing ladders that stabilizes legs standing on uneven terrain and ladders preventing them from swaying. Provides a quick action solution for ladder set-ups in difficult areas, such as stairs, roofs, rocky or sloped ground, etc. utilizes either a hydraulic or manually adjustable system to extend its leveling legs. Insert attachments on either at the ladder base for convenience of use, plus a more stable footing when needed. For users with several ladders of varying length, simply unclamp and move levelers from one ladder to the next.

In one example embodiment, there is provided a ladder leveler system configured for use with a ladder with side rails that has a plurality of rungs spanning between the side rails, each of the rungs having open ends terminating at the side rail. The leveler system includes an elongate frame member or extrusion with a longitudinal axis having a first side surface configured to mate with one of the side rails of the ladder, the first side surface having a least two side posts (extrusions) that extend laterally away from the first side surface that are perpendicular to the longitudinal axis and are configured to be inserted into the open ends of the rungs, a first adjacent surface to the first side surface having locking devices corresponding to each of the side posts, a second side surface of the elongate frame member opposite the first side surface having a height alignment member located thereon. The leveler system also includes an elongate extension leg slidably mounted within the elongate frame member, the extension leg having one or more apertures located on along a length of the elongate extension leg configured for releasable engagement with the height alignment member, the elongate extension leg being extendable out and in from the elongate frame member to adjust the height of the side rail on which it is mounted. The leveler system includes a shoe plate member having a pivotal coupling to a distal end of the elongate extension leg and optionally includes either a shoe pad for enhance gripping or has a surface that is formed with a corrugated pattern to reduce slippage.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIGS. 1A-1D illustrate a perspective view of a ladder leveler system, a right and left side perspective views of a leveler component and a perspective view of the leveler component according to the teachings of the invention.

FIGS. 2A-2D illustrate a front exploded view of the ladder leveler system, a right-side view of the leveler system elements and inset views of engagement of the security hooks of the leveler assembly.

FIGS. 3A-3C illustrate an extended view of an extension leg outside of an elongate frame member, a front view of a shoe plate member of the extension leg and a right-side internal view of the elongate leg extension with a series of apertures for height adjustments.

FIG. 4 illustrate an inside view of the leveler accessory with locking devices to lock the leveler accessory to a side rail of a ladder.

FIG. 5 illustrates a right-side view of the leveler accessory with a height adjustment member located on a first surface of the leveler accessory.

FIG. 6 illustrates a front view of the leveler accessory device.

FIG. 7 illustrates a rear view of the leveler accessory device.

FIGS. 8A-8B illustrate a top and bottom views of the leveler accessory.

FIGS. 9A-9E illustrate a left side perspective and front views of the leveler device having a control button for a hydraulic raising and lowering of the elongate leg extension, and a right, side and top views of the hydraulic leveler accessory according to the teachings herein.

FIG. 10 illustrates a front view of another ladder leveler accessory with cantilevering side extensions for stabilizing a tall ladder from side movement or to provide additional support of the ladder against a wall according to the teachings herein.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

In various embodiments of the invention there is provided a leveling accessory or device having in one embodiment side posts that engage the ladder rungs at the side frame along with a series of security hooks that lock the leveling accessory in place.

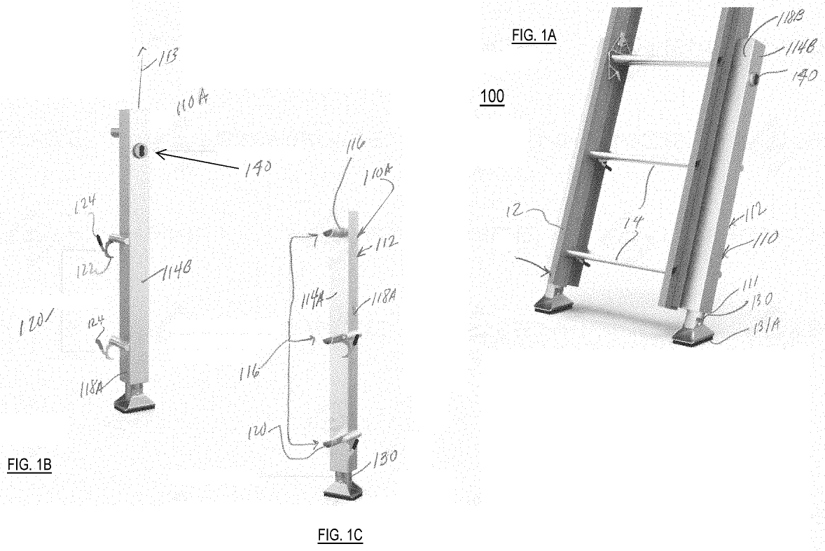

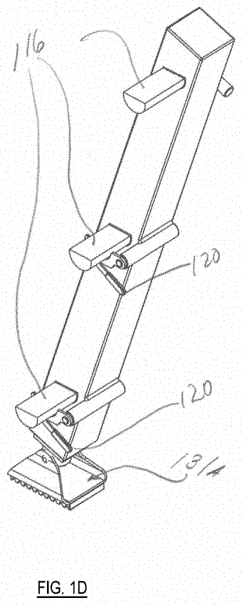

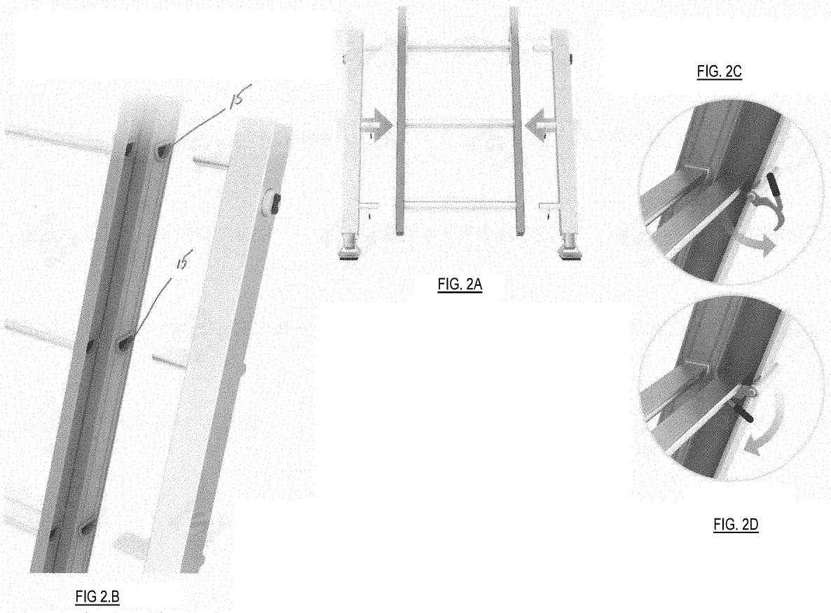

Referring now to the Figures, FIGS. 1A-1D illustrate a perspective view of a ladder leveler system 100, a right and left side perspective views of a leveler component 110 and a perspective view of the leveler component 110 according to the teachings of the invention. Further FIGS. 2A-2D illustrate a front exploded view of the ladder leveler system 100 and a right side view of the leveler system elements 110A and 110B and inset views 2C and 2D of active engagement of the security hooks or devices 120 of the leveler assembly comprised of two leveler components 110A and 110B. In this example embodiment, ladder leveler system 100 is configured for use with a ladder 10 with side rails 12 and having a plurality of rungs 14 spanning between the side rails 12, each of the rungs 14 having open ends 15 terminating at the side rail 12.

In this example embodiment, the leveler component 110 of system 100 includes an elongate frame member 112 with a longitudinal axis 113 having a first side surface 114A configured to mate with one of the side rails 12 of the ladder 10, the first side surface 114A having a least two side posts or pegs 116 that extend laterally away from the first side surface 114A that are perpendicular to the longitudinal axis 113 and are configured to be inserted into the open ends 15 of the rungs 14. A first adjacent surface 118A to the first side surface 114A has locking devices 120 corresponding to each of the side posts 116, a second side surface 114B opposite the first side surface 114A having a height alignment member or control button 140 located thereon for use on the hydraulic version only. In one example embodiment, locking device 120 includes a clamp member or security hook 122 with handle 124 pivotally mounted (in this case a pin and a sleeve mounted on the elongate frame member 110) on the first adjacent surface 118A of the elongate frame member 110 configured to clamp onto a rung 14 of the ladder 10 to releasably lock the elongate frame member 112 to the side rail 12 on which it is mounted.

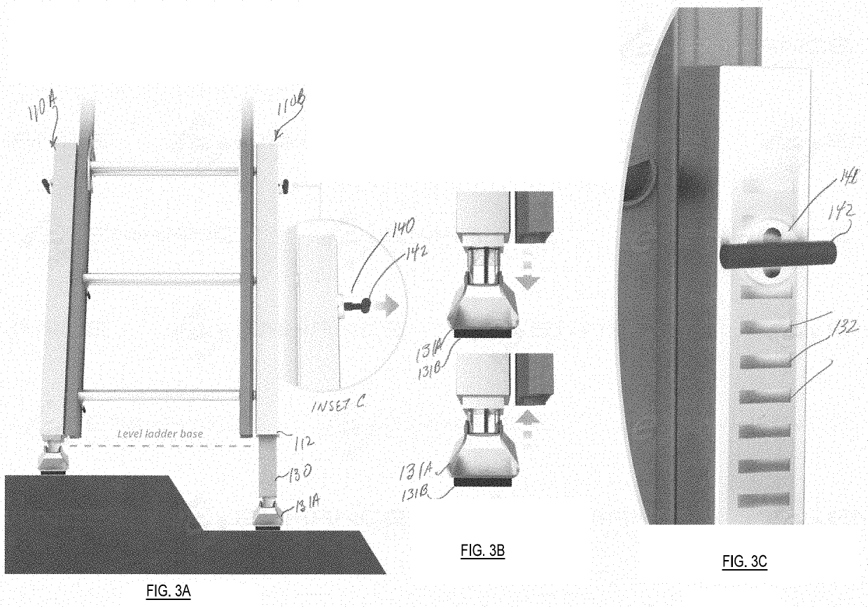

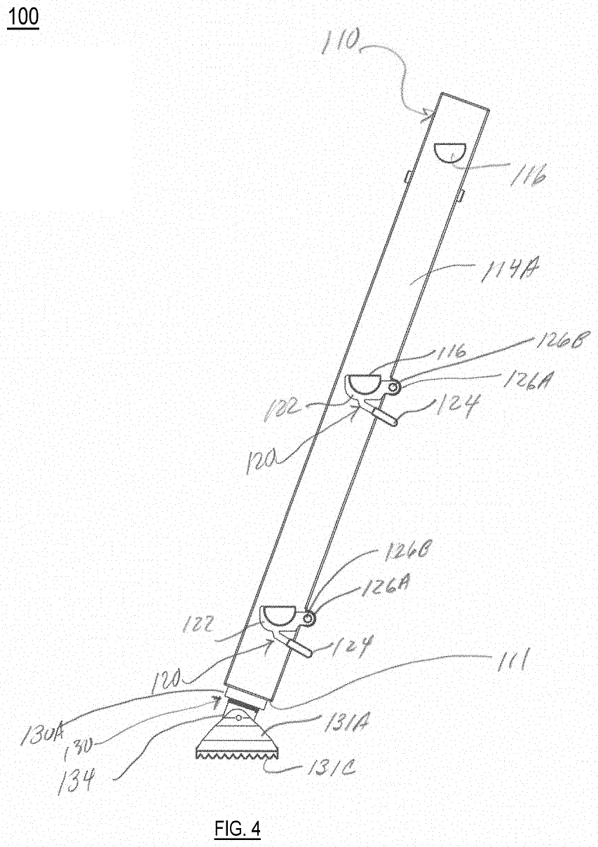

Referring now to FIGS. 3A-3C and 4, there is illustrated an extended view of an extension leg 130 outside of an elongate frame member 112, a front view of a shoe plate member 131A of the extension leg 130 and a right side internal view of the elongate leg extension 130 with a series of apertures 132 for height adjustments. Here leveler system 100 further includes an elongate extension leg 130 that is slidably mounted within the elongate frame member 112, the extension leg 130 having one or more apertures 132 (in this case slots, but can be round or elongate holes) located on and along a length of the elongate extension leg 130 configured for releasable engagement with the height alignment member 140. FIG. 3B illustrates how elongate extension leg 130 is extendable out and in (see arrows) from the elongate frame member 112 to adjust the height of the side rail 12 on which it is mounted. In this example embodiment a shoe plate member 131A has a pivotal coupling 134 that is coupled to a distal end 111 of the elongate frame member 112 and distal end 130A of the elongate extension threaded leg 130. Shoe plate member 131A further includes a shoe pad 131B fastened to a lower face of the shoe plate member 131A. In a related embodiment, shoe pad 131B is eliminated when shoe plate member has a corrugated surface 131C to reduce slippage and enhance gripping to the ground (FIG. 4)

FIGS. 3A-3C further illustrates how a spring-loaded pin 142 protrudes from an aperture 141 in frame member 112 for controlling height adjustment of elongate extension leg 130. In this example embodiment, pin 142 pops out or is pulled out to release the extension leg and adjust the height. Internal extension notches 132 are provided at regular increments for pre-set leg heights.

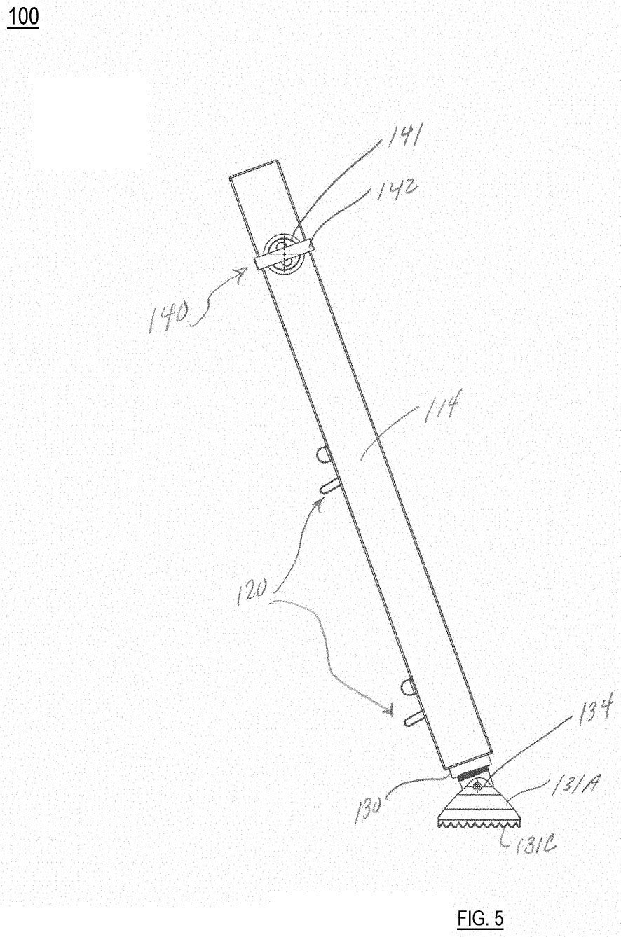

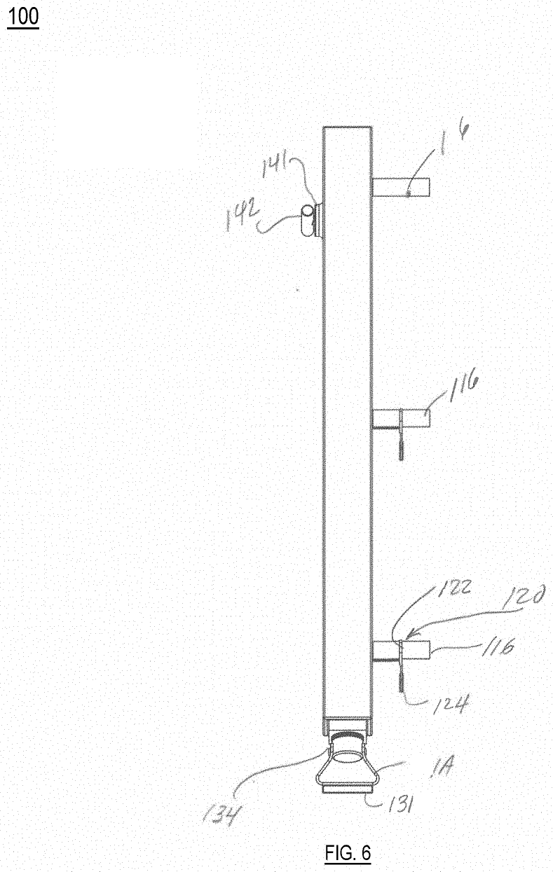

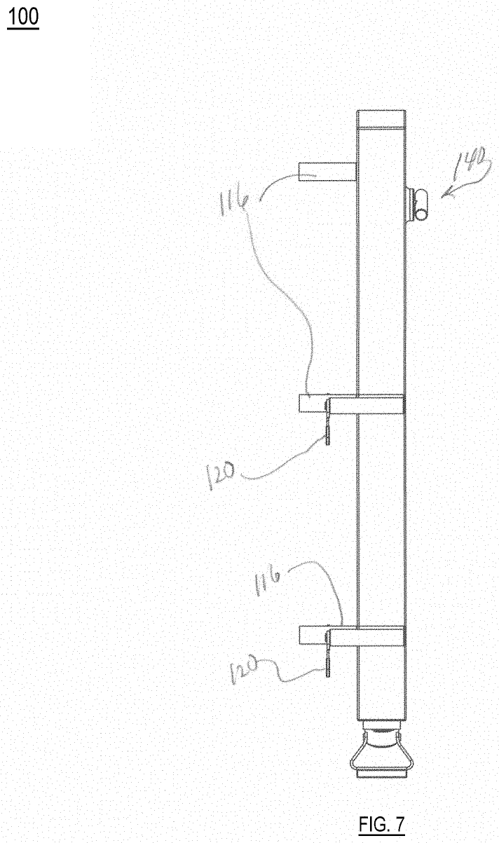

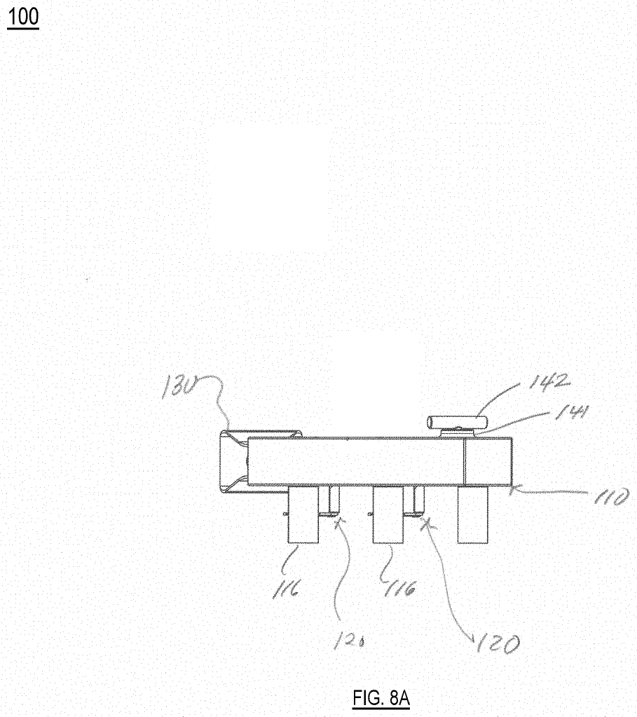

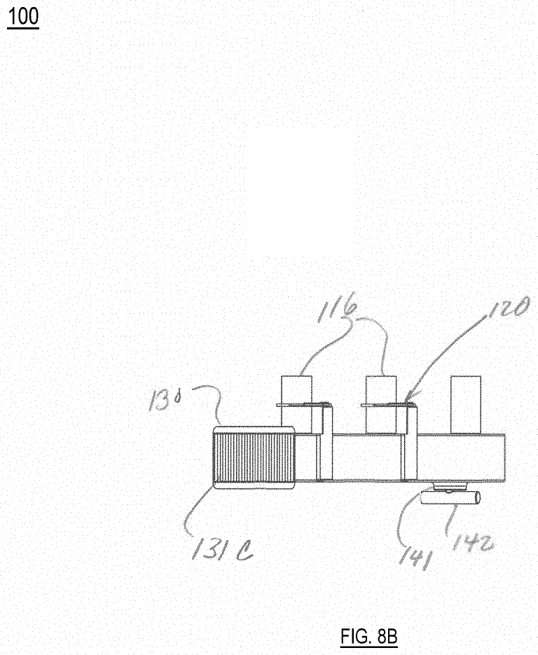

Referring now to FIGS. 4-8, FIG. 4 illustrates an inside view of the leveler accessory 100 with locking devices or security hooks 120 to lock the leveler accessory 100 to a side rail of a ladder. FIG. 5 illustrates a right-side view of the leveler accessory 100 with a height adjustment member 140 located on a first surface 114 of the leveler accessory. FIG. 6 illustrates a front view of the leveler accessory device 100. FIG. 7 illustrates a rear view of the leveler accessory device 100. FIGS. 8A-8B illustrate a top and bottom views of the leveler accessory 100.

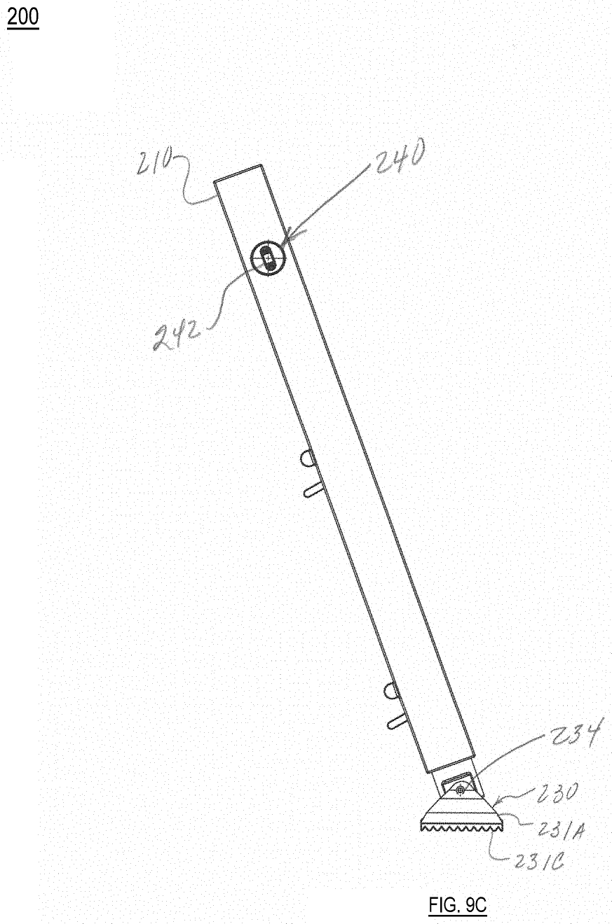

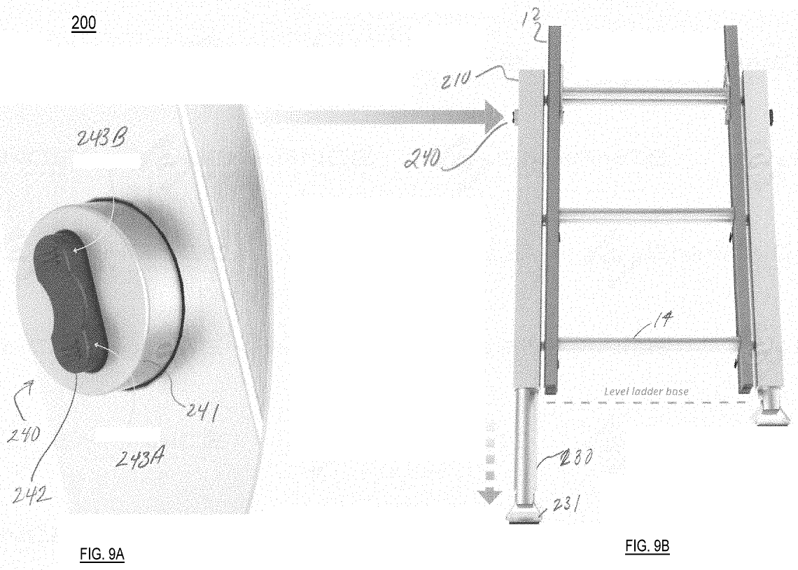

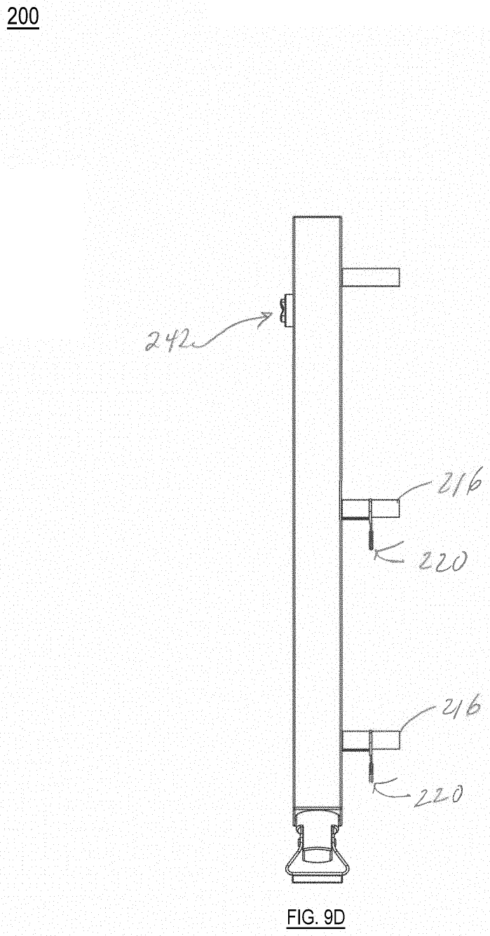

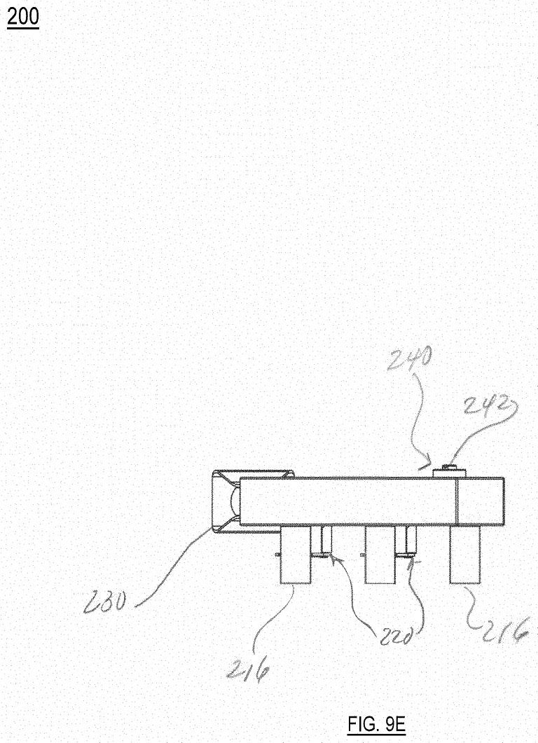

Referring now to FIGS. 9A-9E, there is illustrated various views of a leveling accessory 200 of the present invention having like components to the embodiments described above. The leveler accessory 200 utilizes known components for either hydraulic or electromechanically lifting and lowering of the leg extensions hence any assembly which mechanically, electromechanically or electrically raises/lowers the elongate leg extension would be applicable. Where the system is hydraulic or electromechanical, in an optional embodiment locking devices or clamps 220 as shown are eliminated as the hydraulic or other systems have their own internal lock and brake system to prevent movement when the control button 240 is not engaged.

In one example embodiment, leveler 200 ladder leveler system configured for use with a ladder with side rails and having a plurality of rungs spanning between the side rails, each of the rungs having open ends terminating at the side rail. In this example embodiment, the leveler system 200 includes an elongate frame member 210 with a longitudinal axis having a first side surface configured to mate with one of the side rails of the ladder, the first side surface having a least two side posts 216 that extend laterally away from the first side surface that are perpendicular to the longitudinal axis and are configured to be inserted into the open ends of the rungs, a second side surface of the elongate frame member opposite the first side surface having a height alignment actuator 240 located thereon. Leveler system 200 includes an elongate extension leg 230 slidably mounted within the elongate frame member 210, the extension leg 230 having a lifting assembly (not shown) operatively coupled to the to the extension leg 230 and to the height alignment actuator 240 configured for releasable engagement with the extension leg, wherein the elongate extension leg is extendable out and in from the elongate frame member to adjust the height of the side rail on which it is mounted.

In a related embodiment (not illustrated), the lifting assembly includes a hydraulic assembly is comprised of a pump and motor assembly coupled to a power source, wherein the lifting assembly is responsive to the height adjustment actuator. In another embodiment (not illustrated), the lifting assembly is comprised of a gear assembly and a motor coupled to a power source, wherein the lifting assembly is responsive to the height adjustment actuator.

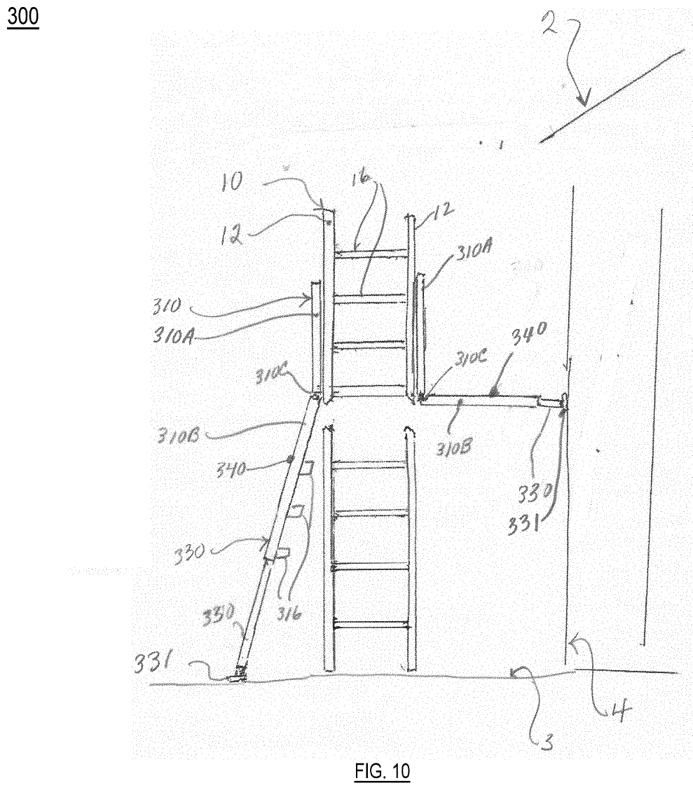

Referring now to FIG. 10, there is illustrated a front view of another stabilizing accessory 300 (which can optionally be used with accessory 100 described above) with cantilevering side extensions 310 for securing a ladder 10 (straight or a-frame type ladders for instance) against a wall 4 of a building 2 located on uneven ground 3 so to keep the ladder from swaying due to weight or wind. In this particular example embodiment, ladder stabilizer accessory 300 is configured for use with a ladder 10 with side rails 12 and having a plurality of rungs 16 spanning between the side rails 12, each of the rungs having open ends terminating at the side rail. In this embodiment, the stabilizer accessory 300 for use with the ladder includes a set of elongate frame members 310, with each elongate frame member formed from a first frame member 310A coupled to a second frame member 310B with a hinge member 310C and configured to cantilever about the hinge member 310C, the elongate frame member 310 having a longitudinal axis.

The first frame member 310A has a first side surface configured to mate with one of the side rails 12 of the ladder, the first side surface having a least two side posts 316 (shown on 310B frame member, for example and are optional) that extend laterally away from the first side surface that are perpendicular to the longitudinal axis and are configured to be inserted into the open ends 15 of the rungs 16, a first adjacent surface to the first side surface having locking devices 320 (not shown; as in FIGS. 1A-1D) corresponding to each of the side posts, the second frame member 310B configured to cantilever away from the side rail 12 of the ladder 10, the second frame member 310B having a second side surface having a height alignment member 340 located thereon. Stabilizer accessory 300 has an elongate extension leg 330 slidably mounted within the second frame member 310B, the extension leg 330 having one or more apertures located on along a length of the elongate extension leg configured for releasable engagement with the height alignment member 340, such that the elongate extension leg is extendable out and in from the second elongate frame member to adjust the height of the side rail on which it is mounted and solidly stabilize ladder.

In a related embodiment, stabilizer accessory 300 further includes a shoe plate member 331 having a pivotal coupling to and at a distal end of each the elongate extension leg 330. Furthermore, the locking device 320 in this embodiment includes a clamp member pivotally mounted on the first adjacent surface of the first frame member of the elongate extension member configured to clamp onto a rung of the ladder to releasably lock the extension frame member to the side rail on which it is mounted.

The following patents are incorporated by reference in their entireties: U.S. Pat. Nos. 4,766,976; 5,609,222; 4,602,432; and 3,861,500.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A ladder leveler system configured for use with a ladder with side rails and having a plurality of rungs spanning between the side rails, each of the rungs having open ends terminating at the side rail, the leveler system comprising:
an elongate frame member with a longitudinal axis having a first side surface configured to mate with one of the side rails openings of the ladder, and solidly stabilize ladder the first side surface having a least two side posts that extend laterally away from the first side surface that are perpendicular to the longitudinal axis and are configured to be inserted into the open ends of the rungs, a first adjacent surface to the first side surface having locking devices corresponding to each of the side posts, a second side surface of the elongate frame member opposite the first side surface having a height alignment member located thereon;
an elongate extension leg slidably mounted within the elongate frame member, the extension leg having one or more apertures located on along a length of the elongate extension leg configured for releasable engagement with the height alignment member, wherein the elongate extension leg is extendable out and in from the elongate frame member to adjust the height of the side rail on which it is mounted; and
a shoe plate member having a pivotal coupling to a distal end of the elongate extension leg.

2. The ladder leveler system of claim 1, wherein the locking device includes a clamp member pivotally mounted on the first adjacent surface of the elongate frame member and configured to clamp onto a rung of the ladder to releasably lock the extension frame member to the side rail to which it is mounted.

3. The ladder leveler system of claim 1, further comprising a shoe pad fastened to a lower face of the shoe plate member.

4. The system of claim 1, wherein the shoe plate member includes a gripping surface selected from the group consisting of a corrugated surface, a rubber or silicone coating or a plurality of numbs formed thereon.

5. A ladder leveler system configured for use with a ladder with side rails and having a plurality of rungs spanning between the side rails, each of the rungs having open ends terminating at the side rail, the leveler system comprising:
an elongate frame member or extrusion with a longitudinal axis having a first side surface configured to mate with one of the side rails of the ladder, the first side surface having a least two side posts that extend laterally away from the first side surface that are perpendicular to the longitudinal axis and are configured to be inserted into the open ends of the rungs, a second side surface of the elongate frame member opposite the first side surface having a height alignment actuator located thereon;
an elongate extension leg slidably mounted within the elongate frame member, the extension leg having a lifting assembly operatively coupled to the to the extension leg and to the height alignment actuator configured for releasable engagement with the extension leg, wherein the elongate extension leg is extendable out and in from the elongate frame member to adjust the height of the side rail on which it is mounted; and
a shoe plate member having a pivotal coupling to a distal end of the elongate extension leg.

6. The system of claim 5, wherein the elongate frame member further comprises a first adjacent surface to the first side surface having locking devices corresponding to each of the side posts.

7. The system of claim 6 wherein the locking device includes a clamp member pivotally mounted on the first adjacent surface of the elongate extension member configured to clamp onto a rung of the ladder to releasably lock the extension frame member to the side rail on which it is mounted.

8. The system of claim 5 wherein the lifting assembly includes a hydraulic assembly is comprised of a pump and motor assembly coupled to a power source, wherein the lifting assembly is responsive to the height adjustment actuator.

9. The system of claim 5 wherein the lifting assembly is comprised of a gear assembly and a motor coupled to a power source, wherein the lifting assembly is responsive to the height adjustment actuator.

10. A ladder leveler accessory configured for use with a ladder with side rails and having a plurality of rungs spanning between the side rails, each of the rungs having open ends terminating at the side rail, the leveler accessory comprising:
at least two elongate frame members, with each elongate frame member formed from a first frame member coupled to a second frame member with a hinge member and configured to cantilever about the hinge member, the elongate frame member having a longitudinal axis, the first frame member having a first side surface configured to mate with one of the side rails of the ladder, the first side surface having a least two side posts or extrusions that extend laterally away from the first side surface that are perpendicular to the longitudinal axis and are configured to be inserted into the open ends of the rungs, a first adjacent surface to the first side surface having locking devices corresponding to each of the side posts, the second frame member configured to cantilever away from the side rail of the ladder, the second frame member having a second side surface having a height alignment member located thereon; and
an elongate extension leg slidably mounted within the second frame member, the extension leg having one or more apertures located on along a length of the elongate extension leg configured for releasable engagement with the height alignment member, wherein the elongate extension leg is extendable out and in from the second elongate frame member to adjust the height of the side rail on which it is mounted.

11. The system of claim 10 further comprising a shoe plate member having a pivotal coupling to and at a distal end of each the elongate extension leg.

12. The system of claim 10, wherein the locking device includes a clamp member pivotally mounted on the first adjacent surface of the first frame member of the elongate extension member configured to clamp onto a rung of the ladder to releasably lock the extension frame member to the side rail on which it is mounted.
